(19) United States
(12) Patent Application Publication
(10) Pub. No.: US 2024/0083731 A1
(43) Pub. Date: Mar. 14, 2024

(54) WRENCH WITH SPECIALIZED GEOMETRY

(71) Applicant: Peter Nielsen, Ridgefield, CT (US)

(72) Inventor: Peter Nielsen, Ridgefield, CT (US)

(21) Appl. No.: 18/242,570

(22) Filed: Sep. 6, 2023

Related U.S. Application Data
(60) Provisional application No. 63/405,524, filed on Sep. 12, 2022.

(51) Int. Cl. B67B 7/18

(52) U.S. Cl. CPC B67B 7/18

(57) ABSTRACT

A wrench for removing a cap on a container including a handle and a head having an inner wall, a plurality of inwardly projecting engagement members configured and dimensioned to fit within a plurality of slots of the cap, a plurality of slots formed between adjacent engagement members, and a taper on the inner wall having an angle substantially complementing an angle of an external wall of the cap.

This application claims priority from provisional application Ser. No. 63/405,524, filed Sep. 12, 2022, the entire contents of which are incorporated herein by reference.

### BACKGROUND OF THE INVENTION

### Field of the Invention

This application is directed to a wrench, and more particularly, to a wrench with a specialized geometry.

### Background

Certain products such as household products come with caps or covers with specific geometries designed to prevent the consumer/user from removing the cap. In certain instances, this can be beneficial as a protective device; however, in other instances, this can lead to excess waste causing increased cost and being more adverse to the environment. It can also lead to extra cost by not allowing the consumer to otherwise replenish the product.

One example is in the Swiffer Wet Jet Product sold by Johnson & Johnson. In this product, the detergent is sealed in a container with a specialized designed cap so that it cannot be removed. That is, a standard wrench cannot be used to loosen the cap to replace (refill) the detergent within the container. In fact, attempts to use conventional wrenches on the cap will only strip or deform the cap without removal.

Frustrated consumers, who for instance want to refill detergent in the container with a less expensive and/or more preferred detergent rather than have to buy a new prefilled container from Johnson & Johnson, have tried various methods of removal, and some have even posted TikTok and YouTube videos to try to set forth the steps for removal. One method, for example, involves submersion into boiling water following by manipulation with various tools. This method is time consuming and oftentimes not successful, let alone requires the risk of using boiling water. Other methods also have had limited success. Requiring replacement of the entire detergent container rather than refilling the existing empty container is not environmentally friendly and is more expensive.

The need exists to provide an easy and reliable method to remove such specialized caps to provide access to the container to overcome the disadvantages enumerated above.

### SUMMARY OF THE INVENTION

The present invention provides a specialized tool to remove covers, i.e., caps (or nuts) in products, such as household products, which are otherwise unopenable due to the manufacturer's intentional design. The tool of the present invention enables removal of the cap (or nut) to access the container so it can be refilled; otherwise, the entire container would need to be discarded and replaced with another pre-filled container. Such removal by the unique tool of the present invention not only reduces costs for the consumer but has environmental benefits by reducing waste. For example, a concentrated solution, such as a detergent, can be purchased and diluted for filling the container. Such diluted solution can provide multiple refills from the single concentrated solution container rather than having to purchase and discard multiple prefilled containers from the manufacturer of the product. Allowing refills also increase choices for the consumers since they are not bound to the company's product, e.g., detergent, which in some instances can be more expensive and/or less desirable.

The description below provides one example of the geometry of the tool of the present invention. The tool can be for the detergent container of the Johnson & Johnson Swiffer Wet Jet product by way of example, it being understood that the tool can be used with other products and can have other geometries and other angles to accommodate different cap geometries. As will be explained below, the tool is designed to complement the ridges of the cap, complement the angle of the outer wall of the cap and also take into account the material of the cap.

In accordance with one aspect of the present invention, a wrench for removing a cover, e.g., a cap or nut, on a container is provided comprising a handle at a proximal region of the wrench and a head at a distal region of the wrench. The head includes an inner wall, a plurality of inwardly projecting engagement members configured and dimensioned to fit within a plurality of slots of the cover, a plurality of slots formed between adjacent engagement members, and a taper on the inner wall having an angle substantially complementing an angle of an external wall of the cover.

In some embodiments, the head defines a closed circumferential area and in some embodiments, extends around 360 degrees to engage the cover around 360 degrees of an external wall of the cover. In some embodiments, the taper of the inner wall extends around 360 degrees around the head.

In some embodiments, the head extends for less than 360 degrees and has an opening to form a C-shape or U-shape. The head when provided with an opening can extend less than 360 degrees and more than 180 degrees.

The angle of the taper of the head can in some embodiments exceed an angle of a taper of the external wall of the cover. In some embodiments, the angle of the taper of the head converges relative to a surface angle of the cover, thereby increasing the interference with the cover and enabling higher torque to be applied.

In some embodiments, the head conforms to a profile of the cover uniformly around a circumference of the cover. In some embodiments, the head engages the cover on multiple planes in an interference engagement.

The plurality of engagement members can include a plurality of ridges extending inwardly from the internal wall of the head toward the center of the head.

In some embodiments, the plurality of engagement members are arranged in an asymmetric pattern; alternatively, they can be arranged in a symmetric pattern.

In some embodiments, one or more of the plurality of engagement members is wider than an adjacent engagement member such that wider and thinner engagement members are provided.

In some embodiments, the wrench includes a ratcheting mechanism.

In some embodiments, the wrench head has a transverse axis extending transverse to a longitudinal axis of the wrench and passes through a center of the head, and the taper of the inner wall of the head tapers outwardly in a direction away from the central transverse axis. The angle of the taper of the inner wall can be equal to an inwardly extending angle of the external wall of the cap; alternatively, the angle of the taper of the inner wall can be greater than an inwardly extending angle of the external wall of the cap.

In accordance with another aspect of the present invention, a wrench for removing a cover, e.g., a cap or nut, on a container is provided comprising a handle at a proximal region and a head at a distal region defining a closed area extending around 360 degrees. The head has an inner wall having a taper angled outwardly with respect to a central transverse axis of the head, the taper angle being equal to or greater than an inwardly tapering angle of the cover.

In some embodiments, a plurality of ridges extend inwardly from an internal wall of the head toward a center of the wrench head and a plurality of slots are formed between the ridges. The angle of the taper of the inner wall can be equal to an inwardly extending angle of the external wall of the cap, or alternatively, greater than an inwardly extending angle of the external wall of the cap.

### BRIEF DESCRIPTION OF THE DRAWINGS

So that those having ordinary skill in the art to which the subject invention pertains will more readily understand how to make and use the apparatus (device) disclosed herein, preferred embodiments thereof will be described in detail hereinbelow with reference to the drawings, wherein:

FIG. 1 is a perspective view of an embodiment of the socket wrench of the present invention, the drawings showing the wrench head;

FIG. 2 is a top view of the socket wrench head of FIG. 1 showing the wrench head engaged with a cap of a currently sold container by way of example;

FIG. 3A is a side view of the wrench of FIG. 1 shown adjacent a cap of a container prior to engagement by the wrench and further showing the corresponding angles, the entire wrench including the head and handle are shown;

FIG. 3B is a view similar to FIG. 3A with the projections/teeth of the wrench head removed for clarity to show the corresponding angles of the internal wall of the wrench head and the external wall of the cap;

FIG. 4 is perspective view of the wrench of FIG. 1 prior to engagement of the cap of FIG. 3A, the entire wrench including the head and handle are shown; and

FIG. 5 is a perspective view showing an example of a specialized cap on a container that can be removed by the socket wrench of FIG. 1 of the present invention due to its specialized geometry.

### DETAILED DESCRIPTION OF PREFERRED EMBODIMENTS

The present invention is directed to a wrench with a specialized geometry designed to engage and rotate to loosen and remove a cap of a container. Note the wrench of the present invention is discussed in terms of removal of a cap of a container but can also be used to remove a cap on other products or a nut on containers or other products. The geometry of the wrench is based on the specific geometry of the cap (or nut) to be engaged, rotated and removed as well as on the material of the cap. More specifically, the wrench head geometry is based on three aspects of the cap to be removed: 1) the ridges and slots of the cap; 2) the angle (slope) of the external wall of the cap; and 3) the material of the cap.

The head of the wrench of the present invention has an arrangement/series of projections (also referred to herein as teeth or ridges) which are configured to fit within the arrangement/series of slots between the ridges on the external wall of the cap. The slots between the projections of the wrench head receive the ridges on the cap. The angle of the inner wall of the wrench head provides a taper that extends 360 degrees around the cap engaging socket. This inner wall angle can vary depending on the softness of the material of the cap to be removed. That is, if the cap material is soft, e.g., rubber, the inner wall angle can be more aggressive for a more aggressive interference fit with the cap; if the cap material is hard, e.g., acrylic, the inner wall angle would be less aggressive. In other words, the angle of the internal wall of the head is intended to complement or substantially complement the angle of the cap, and the closeness of the matching angle to the angle of the cap can depend on the softness or compressibility of the cap.

More specifically, the socket wrench head geometry provides a surface angle which converges relative to the nut/cap surface angle to increase the interference the the nut/cap is inserted into the socket wrench. This allows higher torque to be applied to compliant (soft) nuts and caps. This allows the socket wrench to auto-tighten to a nut/cap without the need for an additional tightening method (lever, roller, etc.). This also allows the socket wrench to tighten on a nut or cap that has a special profile geometry, closing on the profile uniformly around the circumference (eliminating force hot spots). In other words, use of a conventional wrench, even if adjustable, would not uniformly engage such angled cap/nut and would either not provide sufficient interference to grip and rotate the cap or could end up tearing or deforming the cap due to uneven engagement with the cap ridges. In either case, the cap could not be removed. Also, since the cap has as uneven series of spaced apart ridges and slots, a conventional wrench, even if adjustable, without uniform engagement, would strip or deform the ridges around the cap, and in fact, the more torque applied, the greater deformation of the cap. Further, since the cap geometry is tapered, the conventional wrench provides not only a limited but a set interference once engaged. With the present invention, interference actually increases with further insertion of the cap to easily aid removal. Additionally, with a perpendicular internal wall or insufficient complementary angle of a conventional wrench, engagement of the angled wall of the cap on multiple planes is limited.

As used herein, the term “cover” denotes a cap, nut other component placed over a container, the container preferably holding a material/mixture (which can be in a solid form) or a liquid therein. The container can be referred to as a product when used in conjunction with commercially available products containing liquid or solid materials.

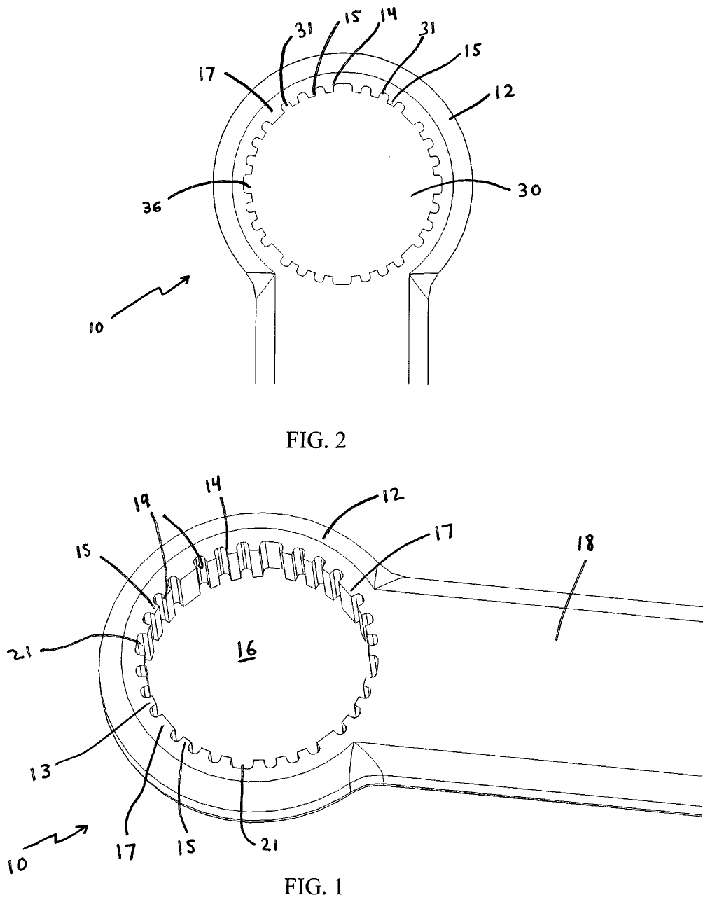

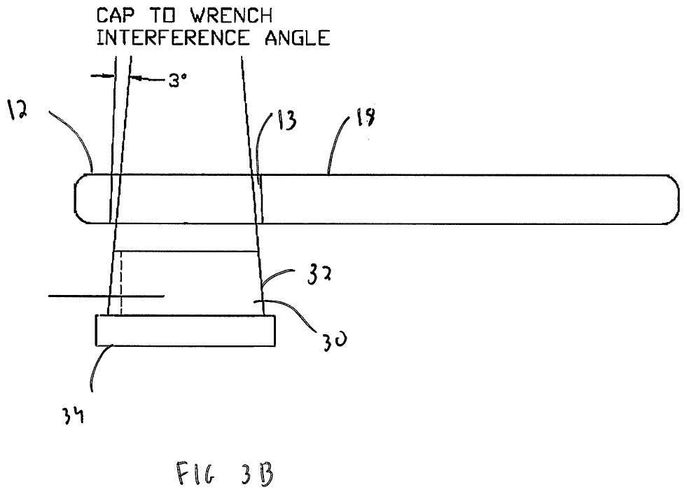

Referring now to the drawings and particular embodiments of the present invention, wherein like reference numerals identify similar structural features of the devices throughout the several views, the socket wrench of the present invention is designated generally by reference numeral 10. The socket wrench 10, as shown in FIGS. 1-4, has a handle 18 for gripping by the user and a closed circumferential area at the wrench head 12 defining a circular opening 16. The wrench head 12 has an internal engagement/gripping surface which includes a series of projections 14 in the form of ridges, teeth or other engagement surfaces to increase frictional/interference engagement with the cap. The projections 14 extend inwardly from internal wall 13 toward the center of the wrench head 12 and are arranged in a pattern to match/complement or substantially match/complement the geometry of the cap to be removed. The pattern can be symmetric or alternatively can be irregular or asymmetric to correspond to the pattern of the ridges of the cap. In the illustrated embodiment, to complement the cap, the projections 14 are arranged in a series/pattern of three projections 15, alternating with wider projections 17 (only a few of which are labeled for clarity). Slots 19 are formed between adjacent projections 15 and 17. As can be appreciated, the pattern/arrangement as well as the size and shape/configuration of the projections (and resulting slots or gaps between the projections) will vary depending on the geometry of the cap to be removed.

The open area 16 is dimensioned to fit over a cap or nut to enclose the cap/nut in a 360 degree engagement and rotate it for loosening and removal. The socket wrench 10 shown in the drawings does not have a ratcheting mechanism but in alternate embodiments can include a ratchet mechanism to apply torque more easily without strain or fatigue.

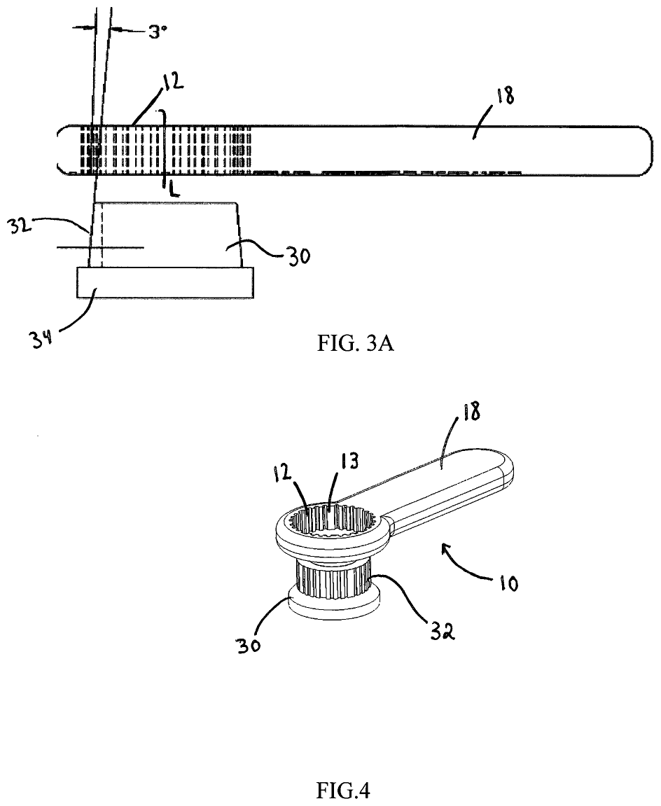

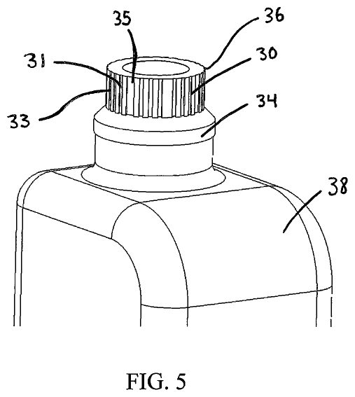

With reference to FIGS. 3A and 3B, the socket wrench head 12 has an outwardly tapered inner wall 13 that is configured to be complementary or substantially complementary with the inwardly angled/tapered outer wall 32 of the cap 30 which angles inwardly from the base 34 which is placed on the container 38 (see FIG. 5). That is, as shown in FIGS. 3A and 3B, cap 30 of container 38 has an outer wall 32 which is angled (sloped) such that it tapers inwardly upwardly (in the orientation of FIG. 3A) away from the lower base portion 34 which engages the container 36 (FIG. 5). This inward taper is in direction toward a center of the cap 30. The outward taper of the cap is in a direction away from a central transverse axis L of the head 12 which is transverse to a longitudinal axis of the wrench 10. (With the wrench head encircling the cap 30, the inward taper of the cap 30 is in a direction toward the central transverse axis L of head 12.) The wall 13 of wrench 10 provides a 360 degree engagement with the outer (external) wall 32 of the cap 30 and has an outward taper that in some embodiments has the same angle as outer wall 32 of cap 30. In alternate embodiments, inner wall 13 of wrench head 12 has a greater angle than the outer wall 32 of cap 30 for an increased frictional engagement. This greater angle/taper can be utilized for caps of soft material. In the example of FIG. 3, the difference in the angle between the inner wall 13 of the socket head 12 and the outer wall 32 of the cap 30 is about 3 degrees, however, it should be understood that other angles are also contemplated. It should be noted that if the cap has multiple tapers, the internal wall 13 of wrench head 12 can be provided with complementary or substantially complementary multiple tapers.

Note as shown in FIG. 5, the cap 30 has a plurality of ridges 31 creating slots 33 (only a few of which are labeled for clarity) therebetween circumferentially around its outer wall. The projections 15 of wrench head 12 engage/complement slots 33 of cap 30, wider projections 17 of head 12 engage/complement slots 35 of cap 30, the ridges 31 of cap 30 engage slots 19 of wrench head 12 and the wider ridges 36 engage the wider slots 21 of head 12 (see also FIG. 2). This, combined with the complementary angle of the wrench head inner wall and cap outer wall, provides sufficient interference fit to rotate and loosen the cap for removal. With the tapering internal wall 14 of head 12, the geometry is uniform as the wrench 10 tightens down on the cap due to its conformance to the outer wall of the cap. Note if the geometry of the outer wall of the cap is different, e.g., the number, size and location of the ridges and slots and/or the angle of the external wall, the geometry of the wrench 10 would be designed accordingly to complement the cap configuration. Thus, the geometry of FIG. 1 is shown by way of example.

As can be appreciated and as noted above, the angle of the taper of the head 12 can in some embodiments exceed an angle of a taper of the external wall of the cover 30. In some embodiments, the angle of the taper of the head 12 converges relative to a surface angle of the cover 30, thereby increasing the interference with the cover and enabling higher torque to be applied. As also noted above, pushing the wrench 10 further down so the head 12 is pushed further down the cap will further increase the interference due to the contrasting geometries, thereby tightening the wrench on the cap.

It should be appreciated that the uniform engagement will reduce any force hot spots when torque is applied, thereby allowing higher forces on softer cap materials without damaging the cap.

Note the terms angle inwardly and angle outwardly are in reference to a center of the wrench head or center of the cover. i.e., inwardly denoting an angle toward a central transverse axis of the head or cover and outwardly denoting an angle away from a central transverse axis of the head, the central transverse axis being transverse to a longitudinal axis. Further note that if the cover had an outward taper instead of an inward taper, the wrench head would be provided with an inward taper instead of an outward taper to provide the aforedescribed complement.

FIG. 5 shows an example of a container used with the Johnson & Johnson Swiffer Wet Jet product which has the cap 30 that cannot be removed by a conventional tool. When the container 38 containing the detergent is empty, the consumer/user cannot open the container to refill it so the user needs to discard the container (so not environmentally friendly) and buy a new pre-filled container (more costly). With the socket wrench of the present invention, cap 30 can be gripped by the head 12 due to the 360 degree interference fit due to the complementary ridges/slots and angle of the wrench with the cap geometry, and the cap 30 can be rotated to loosen and remove it so the container 38 can be filled with the detergent of the user's choosing. The cap 30 can then be reattached to the container and closed by hand, or tightened by using the wrench 10, and later removed by the wrench 10 for another refilling.

Note that the cap configuration and material can vary for different containers provided by the manufacturer or distributor. The wrench of the present invention can be provided as explained above with the necessary taper/angle and projection/slot configuration/arrangement/pattern to accommodate the specific cap.

Note the wrench head has a closed geometric shape to conform to the shape of the cap but alternatively could have different closed shapes such as oval to conform to the geometry of the cap. A fully closed shape is preferable, although it is also contemplated in some embodiments that the wrench head could be a partially open shape, e.g., extending less than 360 degrees and more than 180 degrees such as a U-shape or C-shape as in a flare nut wrench so the opening can be placed around a nut that for example is in a middle portion or obstructed and not accessible via a closed head.

The socket wrench of the present invention can in some embodiments be sold as a kit with one or more other socket wrenches having different tapering angles and/or different projection geometries.

The wrenches of the present invention can be made of various materials such as hard plastics, e.g., acrylonitrile butadiene styrene (ABS), aluminum or stainless steel.

Although the apparatus and methods of the subject invention have been described with respect to preferred embodiments, those skilled in the art will readily appreciate that changes and modifications may be made thereto without departing from the spirit and scope of the present invention as defined by the appended claims. Persons skilled in the art will understand that the various embodiments of the disclosure described herein and shown in the accompanying figures constitute non-limiting examples, and that additional components and features may be added to any of the embodiments discussed herein without departing from the scope of the present disclosure.

It will be understood by those skilled in the art that the above particular embodiments are shown and described by way of illustration only. The principles and the features of the present disclosure may be employed in various and numerous embodiments thereof without departing from the scope and spirit of the disclosure. The above-described embodiments do not restrict the scope of the disclosure.

Additionally, persons skilled in the art will understand that the elements and features shown or described in connection with one embodiment may be combined with those of another embodiment without departing from the scope of the present invention and will appreciate further features and advantages of the presently disclosed subject matter based on the description provided.

Throughout the present disclosure, terms such as “approximately,” “about”, “generally,” “substantially,” and the like should be understood to allow for variations in any numerical range or concept with which they are associated. It is intended that the use of terms such as “approximately”, “about”, “substantially”, and “generally” should be understood to encompass variations on the order of 25%, or to allow for manufacturing tolerances and/or deviations in design.

The recitation of numerical ranges by endpoints includes all numbers within the range.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present invention.

Also, the phrases “at least one of A, B, and C” and “A and/or B and/or C” should each be interpreted to include only A, only B, only C, or any combination of A, B, and C.

What is claimed is:

1. A wrench for removing a cover on a container comprising:
a) a handle at a proximal region of the wrench; and
b) a head at a distal region of the wrench, the head having
i) an inner wall;
ii) a plurality of engagement members configured and dimensioned to fit within a plurality of slots of the cover, the plurality of engagement members projecting inwardly toward a center of the head;
iii) a plurality of slots, a slot of the plurality of slots formed between adjacent engagement members; and
iv) a taper on the inner wall having an angle, the angle substantially complementing an angle of an external wall of the cover.

2. The wrench of claim 1, wherein the head defines a closed circumferential area.

3. The wrench of claim 1, wherein the head extends around 360 degrees to engage the cover around 360 degrees of the external wall of the cover.

4. The wrench of claim 3, wherein the taper of extends around 360 degrees around the head.

5. The wrench of claim 1, wherein the angle of the taper of the inner wall of the head exceeds an angle of the taper of the external wall of the cover.

6. The wrench of claim 1, wherein the angle of the taper of the head converges relative to a surface angle of the cover, thereby increasing the interference with the cover and enabling higher torque to be applied.

7. The wrench of claim 1, wherein the head conforms to a profile of the cover uniformly around a circumference of the cover.

8. The wrench of claim 1, wherein the head engages the cover on multiple planes in an interference engagement.

9. The wrench of claim 1, wherein the plurality of engagement members includes a plurality of ridges extending inwardly from the internal wall of the head toward the center of the head.

10. The wrench of claim 1, wherein the plurality of engagement members are arranged in an asymmetric pattern.

11. The wrench of claim 1, wherein one or more of the plurality of engagement members is wider than an adjacent engagement member.

12. The wrench of claim 1, further comprising a ratcheting mechanism.

13. The wrench of claim 1, wherein the head has a central transverse axis extending transverse to a longitudinal axis of the wrench and passes through a center of the head, and the taper of the inner wall of the head tapers outwardly in a direction away from the central transverse axis.

14. The wrench of claim 13, wherein the angle of the taper of the inner wall of the head is equal to an inwardly extending angle of the external wall of the cap.

15. The wrench of claim 14, wherein the angle of the taper of the inner wall of the head is greater than an inwardly extending angle of the external wall of the cap.

16. The wrench of claim 1, wherein the head forms an open area extending less than 180 degrees.

17. A wrench for removing a cover on a container comprising:
a) a handle at a proximal region; and
b) a head at a distal region, the head defining a closed area extending around 360 degrees, the head having an inner wall having a taper angled outwardly with respect to a central transverse axis of the head, the taper angle being equal to or greater than an inwardly tapering angle of the cover.

18. The wrench of claim 17, further comprising i) a plurality of ridges extending inwardly from an internal wall of the head toward a center of the head; and ii) a plurality of slots.

19. The wrench of claim 17, wherein the angle of the taper of the inner wall of the head is equal to an inwardly extending angle of an external wall of the cap.

20. The wrench of claim 17, wherein the angle of the taper of the inner wall of the head is greater than an inwardly extending angle of an external wall of the cap.
